(19) United States
(12) Patent Application Publication
(10) Pub. No.: US 2024/0357194 A1
(43) Pub. Date: Oct. 24, 2024

(54) Hierarchical Entity Grouping And Entity Reference In Media Content Delivery

(71) Applicant: MediaTek Inc., Hsinchu City (TW)

(72) Inventors: Xin Wang, San Jose, CA (US); Lulin Chen, San Jose (CA)

(21) Appl. No.: 18/638,606

(22) Filed: Apr. 17, 2024

Related U.S. Application Data
(60) Provisional application No. 63/496,703, filed on Apr. 18, 2023.
(60) Provisional application No. 63/504,476, filed on May 26, 2023.
(60) Provisional application No. 63/508,534, filed on Jun. 16, 2023.
(60) Provisional application No. 63/589,353, filed on Oct. 11, 2023.

(51) Int. Cl. H04N 21/266; H04N 21/235; H04N 21/435; H04N 21/462

(52) U.S. Cl. CPC H04N 21/26603; H04N 21/2353; H04N 21/435; H04N 21/462

(57) ABSTRACT

A method of delivering media content, where a streaming server provides a media content to a streaming client. The media content includes multiple media tracks. A first group of entities is specified for the media content. Each entity in the first group of entities is a media track, an item, or a child group of entities. A first data structure is populated to specify one or more arrays of entity identifiers for the first group of entities. Each array of entity identifiers has one or more identifiers of the entities in the first group. Each array of entity identifiers is associated with one reference type that describes the entities identified by the array of entity identifiers. The first data structure is provided to the streaming client, which provides entities of the first group from the media content for playback according to the first data structure.

### CROSS REFERENCE TO RELATED PATENT APPLICATION(S)

The present disclosure is part of a non-provisional application that claims the priority benefit of U.S. Provisional Patent Application Nos. 63/496,703, 63/504,476, 63/508,534, and 63/589,353, filed on 18 Apr. 2023, 26 May 2023, 16 Jun. 2023, 11 Oct. 2023, respectively. Contents of above-listed applications are herein incorporated by reference.

### TECHNICAL FIELD

The present disclosure relates generally to video coding. In particular, the present disclosure relates to methods of delivering media content.

### BACKGROUND

Unless otherwise indicated herein, approaches described in this section are not prior art to the claims listed below and are not admitted as prior art by inclusion in this section.

The International Standard Organization Base Media File Format (ISOBMFF) is a container file format that defines a general structure for files that contain time-based multimedia data such as video and audio. It is designed as a flexible, extensible format that facilitates interchange, management, editing and presentation of the media. The presentation may be local, or via a network or other stream delivery mechanism. The file format is designed to be independent of any particular network protocol while enabling support for any network protocol in general. ISOBMFF has become widely used for media file storage. It is also the basis for various other media file formats (e.g., MP4 and 3GPP container formats).

Dynamic Adaptive Streaming over HTTP (DASH), also known as MPEG-DASH, is an adaptive bitrate streaming technique that enables high quality streaming of media content over the Internet delivered from conventional HTTP web servers. MPEG-DASH works by breaking the content into a sequence of small segments, which are served over HTTP, as HTTP range requests can be used to break the media content into small segments to implement segment-based streaming.

The Common Media Application Format (CMAF) for segmented media is an extensible standard for the encoding and packaging of segmented media objects for delivery and decoding on end user devices in adaptive multimedia presentations. Delivery and presentation are abstracted by a hypothetical application model that allows a wide range of implementations, including MPEG-DASH. The CMAF specification defines several logical media objects such as CMAF track, CMAF switching set, CMAF selection set, CMAF presentation, etc.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method of delivering media content by streaming. A streaming server provides a media content to a streaming client. The media content includes a plurality of media tracks. The media content maybe segmented for the transmission to the streaming client. A first group of entities is specified for the media content. Each entity in the first group of entities is a media track, an item, a track group, or a child group of entities. A first data structure is populated to specify one or more arrays of entity identifiers for the first group of entities. Each array of entity identifiers has one or more identifiers of the entities in the first group. Each array of entity identifiers is associated with one reference type that describes the entities identified by the array of entity identifiers. The first data structure is provided to the streaming client, which provides entities of the first group from the media content for playback according to the first data structure.

The first group of entities may be a preselection specified by a Media Presentation Description (MPD). Each entity in the first group of entities may be a media track, an item, a track group, or a child group of entities (of the first group). Each array of entity identifiers includes one or more identifiers of the entities in the first group.

Each array of entity identifiers is also associated with one reference type that describes the entities identified by the array of entity identifiers. Different arrays of entity identifiers of the first group correspond to different reference types. A reference type for an array of entity identifiers of the first group may indicate that track and track group switching is allowed (“switchable”) during playback of the media content, or that track and/or track group-preselection is allowed (“selectable”) only before playback and not during playback of the media content, or that tracks, track groups and members of a child entity group are to be played back together (“joint”).

In some embodiments, the first group of entities is one of a plurality of groups of entities of the media content. The streaming server provides a second data structure (e.g., groups list box) that specifies a group type for each group in the plurality of groups of entities. The second data structure comprises a plurality of boxes (e.g., entity-to-group boxes) that correspond to the plurality of groups of entities. A box that corresponds to the first group of entities may refer to the first data structure (e.g., entity reference box). The group type specified for the first group of entities may indicate that members of the first group of entities are to be played back together (“joint”), or that the members of the first group of entities have no specified relationship but alternatively during playback (“unspecified”).

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates dynamic adaptation media content delivery.

FIG. 2 illustrates an example data model or data structure of a segmented media presentation being outlined by a manifest.

FIG. 3 shows an example manifest of a segmented media presentation.

FIG. 4 shows the segmented media content partitioned by preselection.

FIG. 5 shows an example data structure for track grouping.

FIG. 6 illustrates an example of using track grouping data structures to implement a multi-level hierarchical grouping.

FIG. 7 shows an example use case of hierarchical grouping, specifically for defining a preselection of CMAF Switching Sets.

FIG. 8 shows another example use case of hierarchical grouping, specifically for assigning segmented video and audio tracks in switchable groups.

FIG. 9 conceptually illustrates using entity reference boxes and entity reference type boxes to associate entity grouping with reference types.

FIG. 10 conceptually illustrates a groups list box that includes several entity-to-group boxes.

FIG. 11 conceptually illustrates a process for providing hierarchical grouping information to streaming clients.

FIG. 12 conceptually illustrates a process for receiving and using hierarchical grouping information from a streaming server.

FIG. 13 conceptually illustrates an example computing environment.

FIG. 14 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

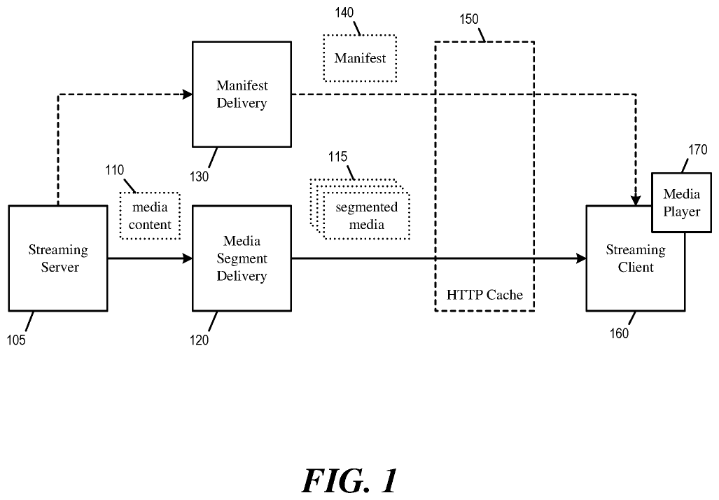

FIG. 1 conceptually illustrates dynamic adaptation media content delivery. As illustrated, a streaming server 105 performs presentation preparation function to provide a media presentation 110. The media presentation 110 is segmented into segmented media content 115 by a media segment delivery function 120, which may be a HTTP server. A manifest delivery function 130 may generate a manifest 140 for the media presentation 110. The segmented media content 115 and the manifest 140 may be cached by a HTTP cache 150 before being delivered to a streaming client 160. The streaming may reconstruct a particular version of the media content by selecting parts of the segmented media content 115. The reconstructed media content 165 may be provided to a media player 170 for video and/or audio playback.

The manifest 140 may be a file in the Media Presentation Description (MPD) format. A manifest such as a MPD file serves as a roadmap for playback of a segmented media presentation. The manifest outlines all the necessary information for smooth playback, including information regarding video and audio segments, codecs, bitrates, and timings.

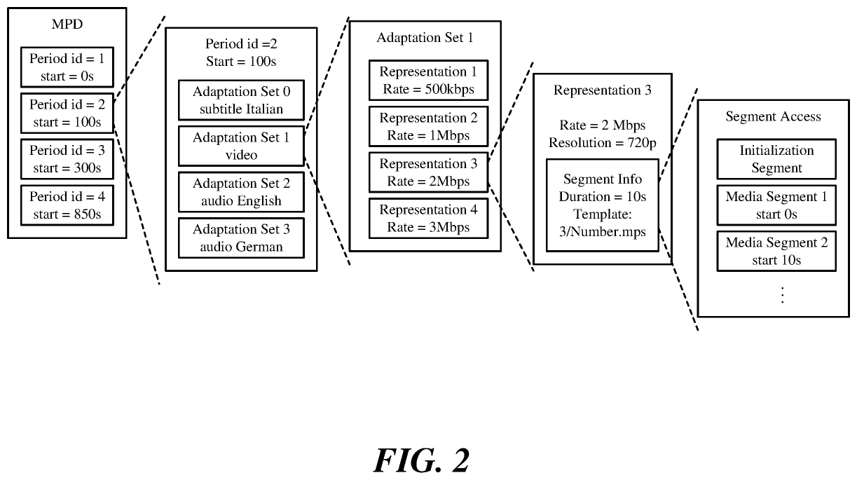

FIG. 2 illustrates an example data model or data structure of a segmented media presentation being outlined by a manifest. The media presentation is segmented according to MPEG DASH. As illustrated, a manifest in MPD format may include descriptions for four periods with four different period IDs that start at different times. The period with period ID=2 includes four different adaptation sets for different tracks. These tracks may be ISOBMFF tracks.

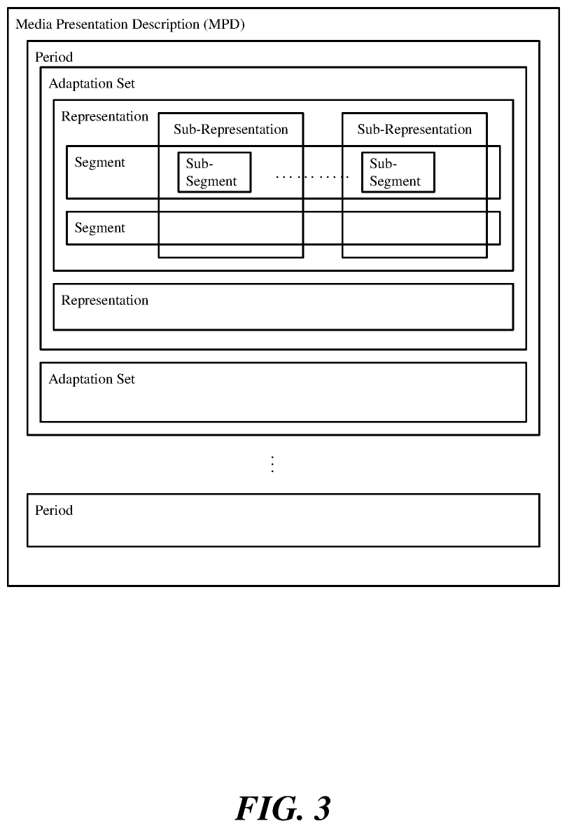

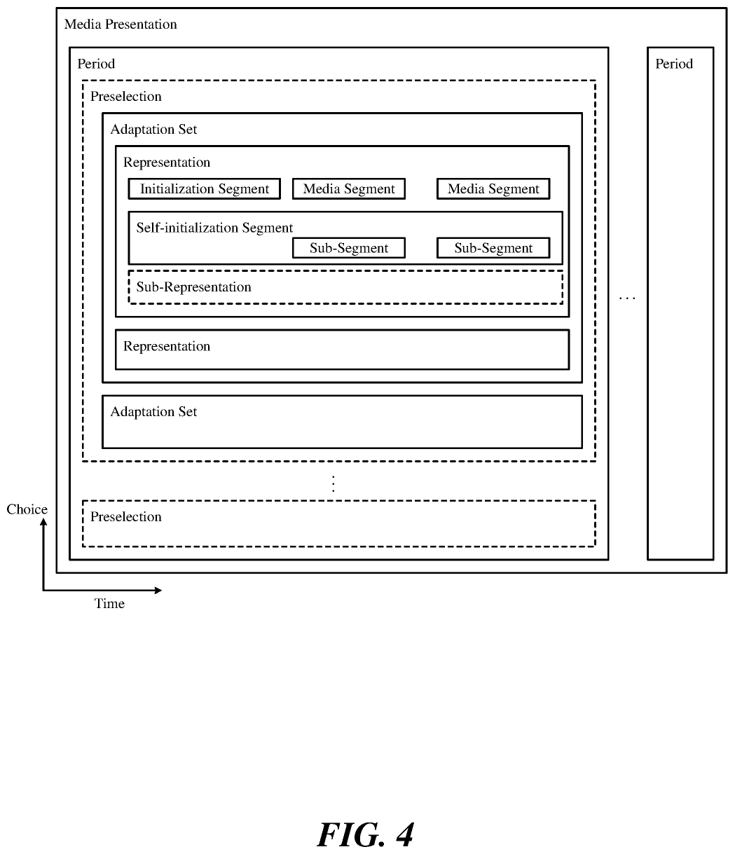

These adaptation sets correspond to different tracks for video, subtitles of one or more languages, audio of one or more languages, etc. Among these, adaptation set 1 (which is an audio track for English) includes four different representations (1-4) that correspond to different data rates and resolutions. Each representation includes a set of segmentation information of the various media presentation segments. FIG. 3 shows an example manifest of a segmented media presentation. The segmented media content may also be partitioned by a preselection, which is shown in FIG. 4. A preselection is a recommended grouping of tracks provided by the streaming server 105 that is conveyed to the streaming client 160.

### 1. Hierarchical Grouping of Media Tracks

Grouping of the ISOBMFF tracks in a segmented media presentation may be defined in a hierarchical manner, e.g., by defining groupings of tracks at two or more levels. One application of multi-level hierarchical grouping is for defining a preselection of CMAF Switching Sets. One or more CMAF Switching Sets of tracks may exist in form of an ISOBMFF file, along with zero or more individual tracks. A preselection track group may be defined to include zero or more CMAF Switching Sets, possibly along with one or more individual tracks. In this preselection, the tracks of a CMAF Switching Set are interchangeable, i.e., any track of the Switching Set has the same property concerning its role in the preselection grouping.

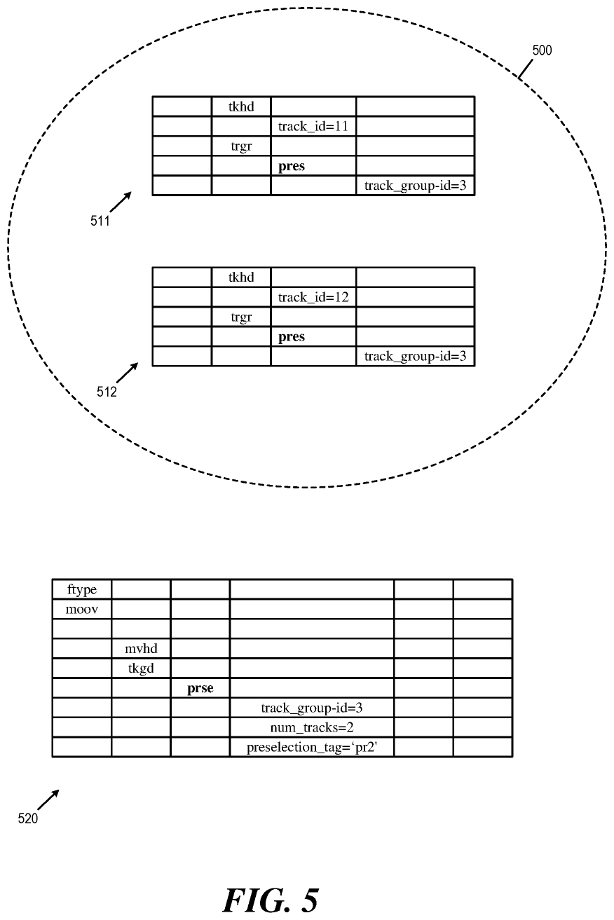

FIG. 5 shows a data structure for track grouping that may be conveyed by the streaming server to the streaming client. The figure illustrates a track grouping 500 for a preselection that includes two individual tracks 511 and 512. the track grouping 500 has an identifier track_group_id=3, and this track_group_id is embedded into each track of the group (track 511 and track 512). The track grouping 500 uses a track group entry box (track_group_entry_box) 520 to record certain common attributes of the track group 500, such as the track_group_id, the number of tracks (num_track=2) and a preselection tag for the preselection. The track group entry box 520 and the individual tracks 511 and 512 also record four-character codes (4cc) that show the properties of the track grouping 500. In this case, ‘prse’ and ‘pres’ are recorded to indicate that the grouping is for a preselection. Each track also may have its own parameters, such as its own track ID (track_id=11 or track_id=12).

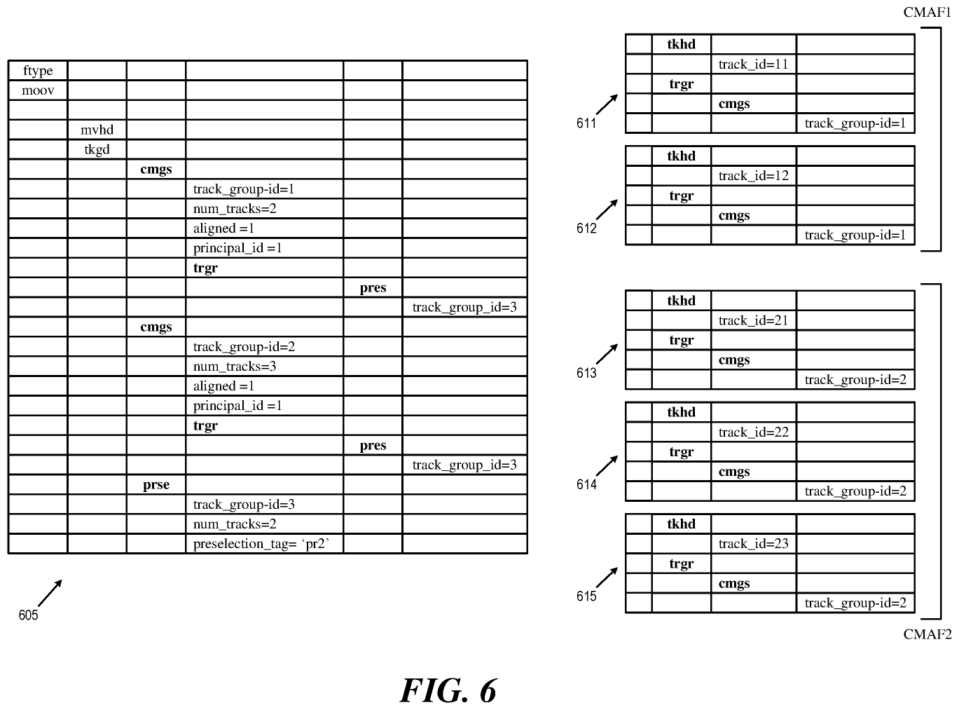

The example of FIG. 5 shows track group entry box that records only the common attributes of the track group, and the track grouping 500 is only a 1-level grouping. In some embodiments, the track group entry box may be used to create multi-level track grouping. FIG. 6 illustrates an example of using track grouping data structures to implement a multi-level hierarchical grouping. Specifically, the figure illustrates a hierarchical track group 600 of individual tracks and other track groups that is formed based on entries in a track group entry box 605.

The figure illustrates individual tracks 611-615 that are members of the hierarchical track group 600. Each individual track has a track entry box, which has a ‘trgr’ box that records the track_group_id of its parent track group. Individual tracks 611 (track_id=11) and 612 (track_id=12) identify themselves as being members of “track_group_id=1”. Individual tracks 613 (track_id=21), 614 (track_id=22), and 615 (track_id=23) identify themselves as being members of “track_group_id=2”. A track group entry box 605 of the hierarchical track group 600 records that, both track groups “track_group_id=1” and “track_group_id=2” are members of a higher-level track_group “track_group_id=3”. In other words, the track groups “track_group_id=1” and “track_group_id=2” are child track groups of a parent track group “track_group_id=3”. This approach accommodates multi-level grouping.

The track group entry box 605 records the number of members of each track group. The number of members in a parent track group is the number of its immediate children. For example, the track group entry box 605 records that “track_group_id=1” has 2 members, “track_group_id=2” has 3 members, while “track_group_id=3” has 2 members.

The track group entry box 605 also records the common attributes of each track group. For example, the “track_group_id=3” is also a preselection group having a preselection tag “preselection_tag= “pr2”. It may be a preselection (indicated by the ‘prse’ box) having two members, CMAF1 (“track_group_id=1”) and CMAF2 (“track_group_id=2”), such that its number_tracks=2. Four-character codes (4cc) in the track group entry box show the property of grouping in e.g., preselection ‘prse’ and ‘pres’ boxes.

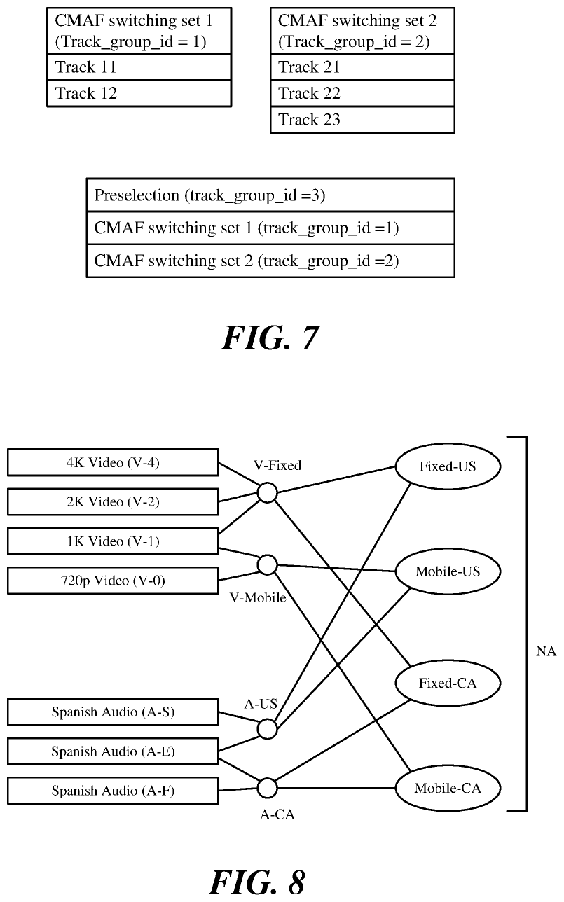

FIG. 7 shows an example use case of hierarchical grouping, specifically for defining a preselection of CMAF Switching Sets. As illustrated, CMAF switching set 1 (track_group_id=1 having tracks 11 and 12) and CMAF switching set 2 (track_group_id=2, having tracks 21, 22, and 23) are defined at a first level of the hierarchical grouping. A preselection (track_group_id=3) is defined at a second level of the hierarchical grouping by including both the CMAF switching sets 1 and 2.

FIG. 8 shows another example use case of hierarchical grouping, specifically for assigning segmented video and audio tracks in switchable groups. The figure shows a media presentation 800 that includes four video tracks (V-0, V-1, V-2, and V-4) and three audio tracks (A-S, A-E, and A-F). The video tracks form two switchable groups, V-Fixed and V-Mobile for fixed devices (e.g., TV and Desktop) and mobile devices (e.g., phone and pad), respectively. The audio tracks form two selectable groups A-US and A-CA, for use in United States and Canada, respectively. In the example, the 1K video track (V-1) is shared in both V-Fixed and V-Mobile groups, and the English audio track (A-E) is in both A-US and A-CA groups.

The switchable groups and the selectable groups are at a first level of hierarchical grouping. The figure shows several experience groups at a second level of hierarchical grouping. These experience groups are formed based on the track groups of the first level. Each experience group is a joint group requiring that a switched video track be playback together with a selected audio track. Specifically, “Fixed-US” experience group includes V-Fixed and A-US groups; “Mobile-US” experience group includes V-Mobile and A-US groups; “Fixed-CA” experience group includes V-Fixed and A-CA groups; and Mobile-CA experience group includes V-mobile and A-CA groups. These experience groups in turn forms a North American experience selectable group, NA, to be differentiated with other experience groups distributed to other regions in the world.

A switchable group (e.g., video track groups) allows track and/or track group switching during playback (e.g., at the segment level), which may be used for bitrate switching. A selectable group (e.g., audio track groups and the experience selectable group) permits track selection between different playback sessions before playback. A joint group (e.g., experience groups) allows selection and/or switching before and during playback, and can be used for preselection.

Grouping track hierarchically may have following requirements: (1) a track group may contain tracks and track groups as its members; (2) a track group may contain members with different (hierarchical) depths, a member depth is defined as 0 for a track and n+1 for a track group where n is max of the depths of the group members; (3) a track group may have overlaps with another track group in terms of their child members, which means that a track or track group may be a child member of one or more groups.

Hierarchical track grouping requires that grouping be indicated by including track_group_id (of the parent group) in each (child) track or each (child) track entry box. (A “box” refers to a data structure that can be populated or updated to associate identifiers, references, and/or data structures. In this example, the child track's track entry “box” associates the child track with the parent group by recording the track_group_id of the parent group.) This means that every time a track group is formed, especially in a late-binding situation, every child track or child track group added to the parent group are required to be updated with at least the track_group_id of the new track group.

Some embodiments of the disclosure provide methods for specifying or building hierarchical track groups that is aligned with ISOBMFF, DASH, and CMAF formats. The method may support track group hierarchies, for e.g., one or more selectable (or pre-selected) groups of switchable groups of tracks. In some embodiments, a track group box is defined for building hierarchical track groups. Track group boxes may be considered as intrinsic to the media tracks being grouped. In some other embodiments, track reference types are defined for using timed metadata tracks as a way to specify track groups. Track reference types may be considered as extrinsic to the media tracks being grouped.

In some embodiments, track group boxes are used to support late binding for track grouping. Specifically, tracks and track groups can be added to a parent group by adding, removing, and editing track group boxes without modifying media tracks themselves. (A child track or a child track group added to a parent group need not be updated with the track_group_id of the parent track group.) In some embodiments, track grouping information are signaled in the timed metadata tracks without modifying the media tracks themselves, the time metadata tracks being tracks separated from the regular media tracks. In some embodiments, using timed metadata tracks facilitates using ISOBMFF files to generate DASH MPD manifest. The use of timed metadata tracks also enables cross-file track grouping based on cross-file track referencing and track group referencing.

For timed metadata tracks in hierarchical track grouping, (track) reference type (reference_type) may have the following values to describe the referenced media tracks and track groups that form the hierarchical track group of tracks and track groups. Examples of the reference types for timed metadata tracks include:
‘hrus’: indicates the presentation relationship is unspecified.
‘hrjt’: indicates the presentation relationship is joint.
‘hrsl’: indicates the presentation relationship is selectable.
‘hrsw’: indicates presentation relationship is switchable.

In some embodiments, a (child) track group may be used as a member of another (parent) track group. To show such association, a track entry box of the child track group may include a box that includes the track_group_id of the parent track group. In this approach, a track group may be a group of individual tracks and other track groups. The grouping is indicated by including track_group_id in each track or in the track entry box of each child group.

In some embodiments, a pairing of track_group_id and track_group_type identifies a track group. Track group type (track_group_type) indicates the track grouping type and may be set to one of the following 4cc values:
‘msrc’: indicates that this track belongs to a multi-source presentation.
‘ster’: indicates that this track is either the left or right view of a stereo pair suitable for playback on a stereoscopic display.
‘pres’: indicates that this track contributes to a preselection.
‘hier’: indicates that this track belongs to a hierarchical group of tracks and track groups.

In some embodiments, hierarchical track groups may be used for processing tracks within the groups. For example, using hierarchical track group allows a track group to be used as an input to a derived (visual) track, doing so has the advantage of treating an output of track derivation as an input to another track group or derived track. For another example, using hierarchical track group allows or extends track groups to contain additional attributes to signal how content carried within track groups should be processed, including to implement temporal track composition or spatial temporal track composition.

In some embodiments, four types of timed metadata tracks corresponding to the four group types (unspecified, joint, selectable, switchable) are used to form hierarchical track groups. This approach introduces four new types of timed metadata tracks, but not new track reference types.

In some embodiments, the tracks that contain a particular track group type box (TrackGroupTypeBox) having the same value of track_group_id and track_group_type belong to the same track group. For example, TrackGroup TypeBox with track_group_type equal to ‘hier’ indicates that this (containing) track is a descendant of a hierarchical track group of tracks and/or track groups. The track is a child member of the hierarchical track group only when member_track is equal to 1, and shall be a descendent of every child member track groups whose track_group_id(s) are listed within the track group type box.

Thus, for some embodiments, a hierarchical track group (of tracks and track groups) is a group whose child members are: (1) all tracks that contain HeriarchicTrackGroupBox with the same value of track_group_id, and all hierarchical track groups that are listed within (at least) one HeriarchicTrackGroupBox with the same value of track_group_id. Child member tracks and track groups of a hierarchical track group are presented according to the group_type of the hierarchical track group. Group type (group_type) indicates a type of the hierarchical group, whose values are provided by Table 1 below:

TABLE 1
Group Types of Hierarchical Groups

| | |
|---|---|
| 0 | Unspecified |
| 1 | Joint: tracks are all needed during playback (or presentation) of |
| | content carried in the members. |
| 2 | Selectable: track selection is only allowed before playback and |
| | no track switching is allowed during playback. |
| 3 | Switchable: track switching is allowed during playback (e.g., at |
| | the segment level). |
| others | Reserved |

Thus, for some embodiments, the example of FIG. 8 may yield the following hierarchical track groups:

| Hier. Track Group | Group Type | Members |
|---|---|---|
| V-Fixed | Switchable | V-4, V-2, V-1 |
| V-Mobile | Switchable | V-1, V-0 |
| A-US | Selectable | A-S, A-E |
| A-CA | Selectable | A-E, A-F |
| Fixed-US | Joint | V-Fixed, A-US |
| Mobile-US | Joint | V-Mobile, A-US |
| Fixed-CA | Joint | V-Fixed, A-CA |
| Mobile-CA | Joint | V-Mobile, A-CA |
| NA | Selectable | Fixed-US, Mobile-US, |
| | | Fixed-CA, Mobile-CA |

These groups can be carried in track group boxes and signed by timed metadata tracks. For example, the 4K video track (V-4) uses the following four hierarchical track group boxes:

| | track_group_{—} | | member_{—} | num_member_{—} |
|---|---|---|---|---|
| box | id | group_type | track | groups |
| 1 | V-Fixed | 3 (switchable) | 1 | 0 |
| 2 | Fixed-US | 1 (joint) | 0 | 2 (V-Fixed, A-US) |
| 3 | Fixed-CA | 1 (joint) | 0 | 2 (V-Fixed, A-CA) |
| 4 | NA | 2 (selectable) | 0 | 2 (Fixed-US, |
| | | | | Fixed-CA) |

The 2K video track (V-2) uses the following four hierarchical track group boxes:

| | track_group_{—} | | member_{—} | num_member_{—} |
|---|---|---|---|---|
| box | id | group_type | track | groups |
| 1 | V-Fixed | 3 (switchable) | 1 | 0 |
| 2 | Fixed-US | 1 (joint) | 0 | 2 (V-Fixed, A-US) |
| 3 | Fixed-CA | 1 (joint) | 0 | 2 (V-Fixed, A-CA) |
| 4 | NA | 2 (selectable) | 0 | 2 (Fixed-US, Fixed- |
| | | | | CA) |

The 1K video track (V-1) uses the following seven hierarchical track group boxes:

| | track_group_{—} | | member_{—} | num_member_{—} |
|---|---|---|---|---|
| box | id | group_type | track | groups |
| 1 | V-Fixed | 3 | 1 | 0 |
| | | (switchable) | | |
| 2 | V-Mobile | 3 | 1 | 0 |
| | | (switchable) | | |
| 3 | Fixed-US | 1 (joint) | 0 | 2 (V-Fixed, A-US) |
| 4 | Mobile-US | 1 (joint) | 0 | 2 (V-Mobile, A-US) |
| 5 | Fixed-CA | 1 (joint) | 0 | 2 (V-Fixed, A-CA) |
| 6 | Mobile-CA | 1 (joint) | 0 | 2 (V-Mobile, A-CA) |
| 7 | NA | 2 | 0 | 4 (Fixed-US, |
| | | (selectable) | | Mobile-US, Fixed-CA, |
| | | | | Mobile-CA) |

The 720 video track (V-0) uses the following four hierarchical track group boxes:

| | track_group_{—} | | member_{—} | num_member_{—} |
|---|---|---|---|---|
| box | id | group_type | track | groups |
| 1 | V-Mobile | 3 (switchable) | 1 | 0 |
| 2 | Mobile-US | 1 (joint) | 0 | 2 (V-Mobile, |
| | | | | A-US) |
| 3 | Mobile-CA | 1 (joint) | 0 | 2 (V-Mobile, |
| | | | | A-CA) |
| 4 | NA | 2 (selectable) | 0 | 2 (Mobile-US, |
| | | | | Mobile-CA) |

The Spanish audio track (A-S) uses the following four hierarchical track group boxes:

| | track_group_{—} | | member_{—} | |
|---|---|---|---|---|
| box | id | group_type | track | num_member_groups |
| 1 | A-US | 2 (selectable) | 1 | 0 |
| 2 | Fixed-US | 1 (joint) | 0 | 2 (V-Fixed, A-US) |
| 3 | Mobile-US | 1 (joint) | 0 | 2 (V-Mobile, A-US) |
| 4 | NA | 2 (selectable) | 0 | 2 Fixed-US, |
| | | | | Mobile-US) |

The English audio track (A-E) uses the following seven hierarchical track group boxes:

| | track_group_{—} | | member_{—} | |
|---|---|---|---|---|
| box | id | group_type | track | num_member_groups |
| 1 | A-US | 2 (selectable) | 1 | 0 |
| 2 | A-CA | 2 (selectable) | 1 | 0 |
| 3 | Fixed-US | 1 (joint) | 0 | 2 (V-Fixed, A-US) |
| 4 | Mobile-US | 1 (joint) | 0 | 2 (V-Mobile, A-US) |
| 5 | Fixed-CA | 1 (joint) | 0 | 2 (V-Fixed, A-CA) |
| 6 | Mobile-CA | 1 (joint) | 0 | 2 (V-Mobile, A-CA) |
| 7 | NA | 2 (selectable) | 0 | 4 (Fixed-US, |
| | | | | Mobile-US, Fixed-CA, |
| | | | | Mobile-CA) |

The French audio track (A-F) uses the following four hierarchical track group boxes:

| | track_group_{—} | | member_{—} | |
|---|---|---|---|---|
| box | id | group_type | track | num_member_groups |
| 1 | A-CA | 2 (selectable) | 1 | 0 |
| 2 | Fixed-CA | 1 (joint) | 0 | 2 (V-Fixed, A-CA) |
| 3 | Mobile-CA | 1 (joint) | 0 | 2 (V-Mobile, A-CA) |
| 4 | NA | 2 (selectable) | 0 | 2 (Fixed-CA, |
| | | | | Mobile-CA) |

In some embodiments, a hierarchical track group can be logically formed based on timed metadata tracks. Such a hierarchical track group can be formed or updated by adding/editing/removing track group boxes corresponding to the timed metadata tracks, without modification to the video and audio tracks. The following are nine track group boxes corresponding to nine timed metadata tracks for the example of FIG. 8.

| | metadata | | |
|---|---|---|---|
| box | track_id | reference_type | Referenced track_id's |
| 1 | V-Fixed | hrsw (switchable) | V-4, V-2, V-1 |
| 2 | V-Mobile | hrsw (switchable) | V-1, V-0 |
| 3 | A-US | hrsl (selectable) | A-S, A-E |
| 4 | A-CA | hrsl (selectable) | A-E, A-F |
| 5 | Fixed-US | hrjt (joint) | V-Fixed, A-US |
| 6 | Mobile-US | hrjt (joint) | V-Mobile, A-US |
| 7 | Fixed-CA | hrjt (joint) | V-Fixed, A-CA |
| 8 | Mobile-CA | hrjt (joint) | V-Mobile, A-CA |
| 9 | NA | hrsl (selectable) | Fixed-US, Mobile-US, |
| | | | Fixed-CA, Mobile-CA |

Some embodiments of the disclosure provide a method for building hierarchical track groups that is late-binding friendly, i.e., there is no need to update any existing member track or track groups when a new track group is formed. Late-binding in the context of media content delivery refers to associating content segments to identifiers or groupings after the content segments are generated. The method supports late-binding for track grouping by allowing adding, removing, and editing track group boxes without modifying member tracks. ISOBMFF files can be used to generate DASH MPDs without introducing track group boxes within tracks to be grouped. The method also enables cross-file track grouping, when cross-file track referencing and track group referencing become available.

In some embodiments, track grouping information is signaled in a track group description box (TrackGroupDescriptionBox), separated from member media tracks. TrackGroupDescriptionBox provides an array of track group entry boxes (TrackGroupEntryBox), where each TrackGroupEntryBox provides detailed characteristics of a particular track group. TrackGroupEntryBox is mapped to the track group by a unique track group entry type (track_group_entry_type) that is associated with a track group type. In some embodiments, the track group entry type is defined to indicate a type of the track group in a manner similar to group type, namely one of unspecified (0), joint (1), selectable (2), and switchable (3).

TrackReferenceTypeBox may be used to indicate the member tracks and/or track groups of the track group. A ‘cdtg’ track reference indicates referenced member tracks and track groups to be considered collectively. This way, how the referenced members are related to each other is determined according to the value of track_group_entry_type.

More than one TrackGroupEntryBox(es) with the same track_group_entry_type may be present in TrackGroupDescriptionBox, in that case TrackGroupEntryBox(es) shall have different track_group_id. A pairing of track_group_id and track_group_entry_type may identify the track group that the TrackGroupEntryBox describes. A TrackGroupEntryBox may contain a TrackGroupBox (‘trgr’). If this is the case, each TrackGroupTypeBox within the TrackGroupBox indicates that the track group under description is a member of another track group identified by the track_group_id in the TrackGroupTypeBox. For example, all attributes uniquely characterizing a preselection may be present in a TrackGroupEntryBox for the preselection.

In some embodiments, a track group entry box is used to define a group of tracks and/or track groups, in which a track group entry box contains a track reference box to indicate: (1) a group type for how its member tracks and/or track groups are related to each other with one of the new values of track group entry type (track_group_entry_type), or (2) the group's member tracks and track groups, and with one of the new values of reference_type to indicate a group type for how its member tracks and track groups are related to each other. For some embodiments, the reference type of a track or a group can be set to one of the following 4cc values listed in Table 2 below:

TABLE 2
Reference Types

| 4cc | Description |
|---|---|
| hint | The referenced track(s) contain the original media for this hint track. |
| cdsc | Links a descriptive or metadata track to the content which it describes. |
| font | This track uses fonts carried/defined in the referenced track. |
| hind | Indicates that the referenced track(s) may contain media data required for |
| | decoding of the track containing the track reference, i.e., it should only |
| | be used if the referenced hint track is used. The referenced tracks shall be |
| | ‘hint’ tracks. The ‘hind’ dependency can, for example, be used for |
| | indicating the dependencies between hint tracks documenting layered IP |
| | multicast over RTP. |
| vdep | This track contains auxiliary depth video information for the referenced |
| | video track. |
| vplx | This track contains auxiliary parallax video information for the |
| | referenced video track. |
| subt | This track contains subtitle, timed text or overlay graphical information |
| | for the referenced track or any track in the alternate group to which the |
| | track belongs, if any. |
| thmb | This track contains thumbnail images for the referenced track. A |
| | thumbnail track shall not be linked to another thumbnail track with the |
| | ‘thmb’ item reference. |
| auxl | This track contains auxiliary media for the indicated track (e.g., depth |
| | map or alpha plane for video). |
| cdtg | The referenced media tracks and track groups are described collectively; |
| | the ‘cdtg’ track reference shall only be present in timed metadata tracks. |
| shsc | Links a shadow sync track to a main track. |
| hgus | The referenced tracks and track groups form a (hierarchical) track group |
| | of tracks and track groups, whose presentation relationship is unspecified. |
| hgjt | The referenced tracks and track groups form a (hierarchical) track group |
| | of tracks and track groups, whose presentation relationship is joint: all |
| | group members are needed for presentation. |
| hgsl | The referenced tracks and track groups to form a (hierarchical) track |
| | group of tracks and track groups, whose presentation relationship is |
| | selectable: only one selected before presentation is needed for |
| | presentation. |
| hgsw | The referenced tracks and track groups form a (hierarchical) track group |
| | of tracks and track groups, whose presentation relationship is switchable: |
| | only one is needed for presentation but the one can be switched to another |
| | during presentation. |
| hgsq | The referenced tracks and track groups form a (hierarchical) track group |
| | of tracks and track groups, whose presentation relationship is sequential: |
| | all group members are needed for presentation in the order of their |
| | references. |

In some embodiments, when an existing track or track group is grouped or added into another group, the existing track or track group are not required to be modified. In this sense, the solution is late-binding friendly. To accomplish this, in some embodiments, track group entry type is used to indicate a group type for how its member tracks and track groups are related to each other, with newly defined values, instead of using the new values of track reference type, reference_type, when referencing member tracks and track groups.

In some embodiments, hierarchical track grouping is implemented by entity grouping, i.e., by treating tracks as members of entity groups. An entity group is a grouping of entities, each of which can be a track or an item that is not a track. An entity reference is used to represent or identify the entity group. The entities in an entity group share a particular characteristic or have a particular relationship, as indicated by a grouping type of the entity group. For example, hierarchical entity groups can be used to build preselection groups as hierarchical groups of CMAF switching groups.

Since any member of an entity group has to be either an item or a track (identified by an item_id or a track_id), an entity group cannot be a member of another (higher-level) entity group. To support hierarchical or multi-level entity grouping, in some embodiments, entity references (including those for entity groupings) are assigned entity reference types. Unlike designs in which entity references are not typed, using entity reference types for entity grouping allows entity references to be consistent with track and item references in terms of type, thereby allowing an entity group to be a member of another (higher-level) entity group.

In some embodiments, an entity reference box (EntityReferenceBox) is defined (and conveyed by the server to the client) to enable the use of entity reference types. An entity reference box may include one or more entity reference type boxes (EntityReferenceTypeBox). Each EntityReferenceTypeBox indicates, by its reference type, that the enclosing entity (an item, a track, or an entity group) includes one or more (entity) references of that reference type. Each reference type shall occur at most once in the entity reference box as an entity reference type box. Within each Entity Reference Type Box there is a reference array of entity IDs (entity_IDs). Within a given reference array, a given value shall occur at most once (i.e., must be unique within the array). Other data structures in the file formats may index through these arrays (index values start at 1).

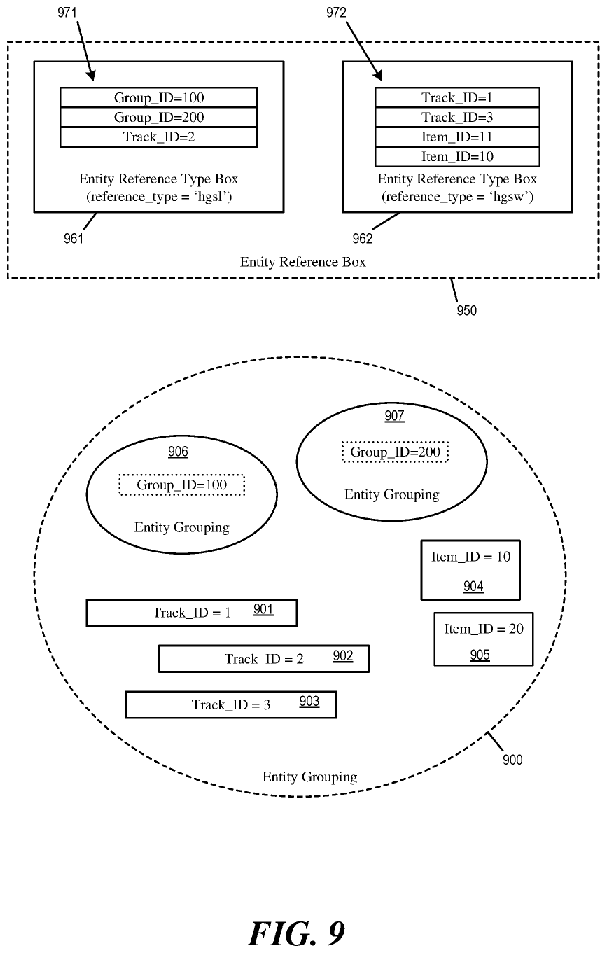

FIG. 9 conceptually illustrates using entity reference boxes and entity reference type boxes to associate entity grouping with reference types. As illustrated, an entity group 900 has members 901-907. Members 901-903 are tracks with track_IDs ‘1’, ‘2’, and ‘3’, respectively. Members 904 and 905 are items with item_IDs ‘10’, and ‘20’, respectively. Members 906 and 907 are entity groups with group IDs ‘100’ and ‘200’. The entity group 900 is therefore a multi-level hierarchical group.

An entity reference box 950 is used to associate entities in the entity group 900 with their respective reference types. The entity reference box 950 is a data structure conveyed to the streaming client by the streaming server along with the segmented media content. The entity reference box 950 includes several entity reference type boxes 961 and 962. The entity reference type box 961 is for a first reference type (say, ‘hgsl’) and the entity reference type box 962 is for a second, different reference type (say, ‘hgsw’). Each reference entity type box has an array of entity IDs, which may include IDs of tracks, items, or entity groups that share the reference type of the reference entity type box.

The array of entity IDs is an array of integers providing the entity identifiers of the referenced entities (items or tracks) or group ID values of the referenced entity groups. Each value entity_IDs [i], where i is a valid index to the entity_IDs [ ] array, is an integer that provides a reference from the containing entity to the entity (item, track or entity group) with its ID (item_ID, track_ID, or group_ID) equal to entity_IDs [i] or to the entity group with both group_id equal to entity_IDs [i] and (flags & 1) of Entity Group Type Box (EntityGroupTypeBox) equal to 1. When a group_id value is referenced, the entity reference applies to each entity of the referenced entity group individually unless stated otherwise in the semantics of particular entity reference types. In some embodiments, the value 0 shall not be present. In the entity ID array there is no duplicated value; however, an entity_ID may appear in the array and also be a member of one or more entity groups for which the group IDs appear in the array. This means that in forming the list of entities, after replacing group_IDs by the entity_IDs of the entities in those groups, there might be duplicate entity_IDs. A group_ID shall not be used when the semantics of the reference requires that the reference be to a single entity.

In some embodiments, the reference types defined in a track reference box (or other registered reference types) may be used for entity references. This includes various reference types for forming various entity groups, such as “joint”, “selectable”, “switchable”, and “sequential”. Each of the reference types describes the referenced tracks and track groups to form a hierarchical track group of tracks and track groups. Examples of the reference types include previously defined ‘hgus’, ‘hgjt’, ‘hgsl’, ‘hgsw’, and ‘hgsq’.

In some embodiments, multiple entity groups may be indicated in a groups list box (GroupsListBox). Entity groups specified in GroupsListBox of a file-level meta box (MetaBox) refer to tracks or file-level items. Entity groups specified in GroupsListBox of a movie-level MetaBox refer to movie-level items. Entity groups specified in GroupsListBox of a track-level MetaBox refer to track-level items of that track. When GroupsListBox is present in a file-level MetaBox, there shall be no item_ID value in ItemInfoBox in any file-level MetaBox that is equal to the track_ID value in any TrackHeaderBox.

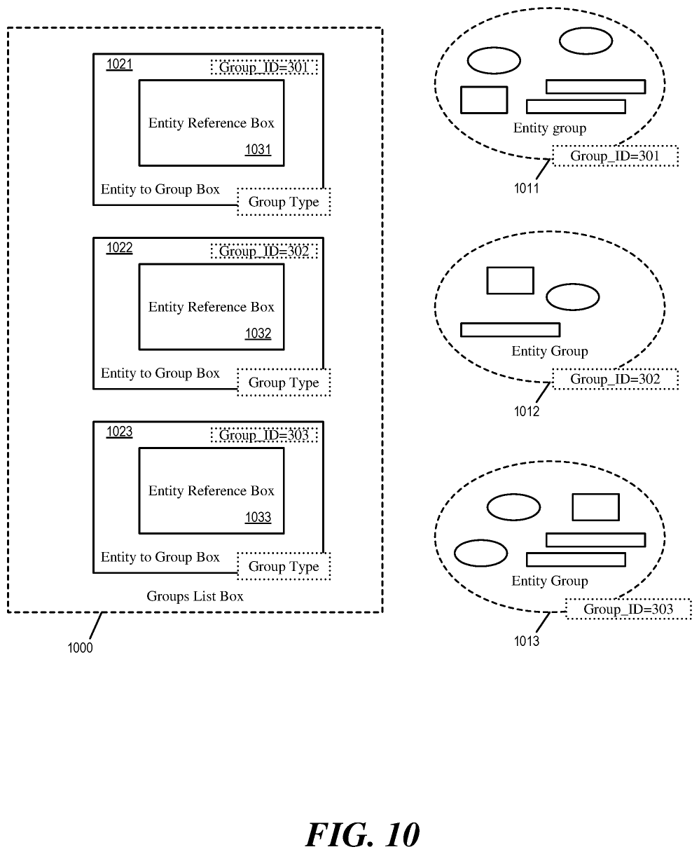

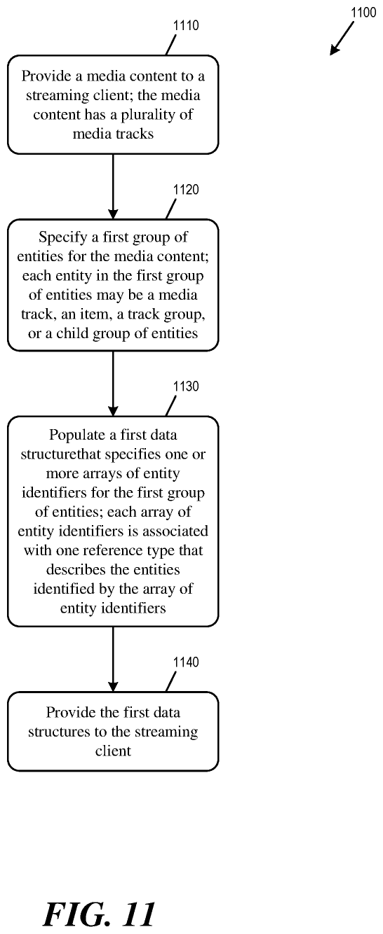

GroupsListBox may contain multiple entity-to-group boxes (Entity ToGroupBox), each EntityToGroupBox specifying one of the entity groups indicated by the GroupsListBox. Each EntityToGroupBox is typed to indicate the grouping type (grouping_type) of the entity group. FIG. 10 conceptually illustrates a groups list box 1000 that includes several entity-to-group boxes. The groups list box 1000 has entity-to-group boxes 1021-1023 that are used to associate grouping types (group_type) with different entity groupings 1011-1013. Each entity-to-group box (Entity ToGroupBox) also includes an entity reference box (EntityRefereneBox) for associating reference types to members of the associated entity group as described by reference to FIG. 9 above.

For each grouping type, a grouping type code (e.g., 4cc) is used to associate the grouping type with semantics that describe the grouping. A grouping type can be one of the reference types described in Table 2 above.

An additional example grouping type is ‘altr’, which indicates that the items and tracks mapped to this grouping are alternatives to each other, and only one of them should be played (when the mapped items and tracks are part of the presentation; e.g. are displayable items or tracks) or processed by other means (when the mapped items or tracks are not part of the presentation; e.g. are metadata). A media player (e.g., a streaming client) may select the first entity from the list of entity_id values that it can process (e.g., decode and play for mapped items and tracks that are part of the presentation) and that suits the application's needs.

FIG. 11 conceptually illustrates a process 1100 for providing hierarchical grouping information to streaming clients. In some embodiments, one or more processing units (e.g., a processor) of a computing device implementing the streaming server 105 performs the process 1100 by executing instructions stored in a computer readable medium. In some embodiments, an electronic apparatus implementing the streaming server 105 performs the process 1100.

The server provides (at block 1110), a media content to a streaming client. The media content includes a plurality of media tracks. The media content maybe segmented for the transmission to the streaming client.

The server specifies (at block 1120) a first group of entities for the media content. Each entity in the first group of entities may be a media track, an item, a track group or a child group of entities. The first group of entities may be a preselection specified by a Media Presentation Description (MPD).

The server populates (at block 1130) a first data structure (e.g., an entity reference box) that specifies one or more arrays of entity identifiers (e.g., entity reference type boxes) for the first group of entities. Each array of entity identifiers includes one or more identifiers of the entities in the first group. An array of entity identifiers may include identifiers for tracks, items, or groups of entities.

Each array of entity identifiers is associated with one reference type that describes the entities identified by the array of entity identifiers. Different arrays of entity identifiers of the first group correspond to different reference types. A reference type for an array of entity identifiers of the first group may indicate that track or track group switching is allowed (“switchable”) during playback of the media content, or that track and/or track group preselection is allowed (“selectable”) only before playback and not during playback of the media content, or that members of a child entity group are to be played back together (“joint”).

In some embodiments, the first group of entities is one of a plurality of groups of entities of the media content. The streaming server provides a second data structure (e.g., groups list box) that specifies a group type for each group in the plurality of groups of entities. The second data structure comprises a plurality of boxes (e.g., entity-to-group boxes) that correspond to the plurality of groups of entities. A box that corresponds to the first group of entities may refer to the first data structure (e.g., entity reference box). The group type specified for the first group of entities may indicate that members of the first group of entities are to be played back together (e.g., “joint”), or that the members of the first group of entities have no specified relationship during playback (“unspecified”).

The server provides (at block 1140) the first data structures to the streaming client. The first data structure may be used by a media player to select entities from the media content for playback.

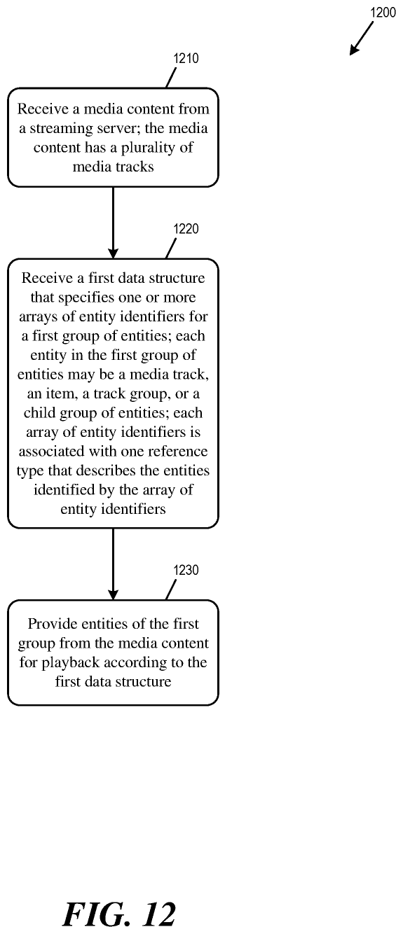

FIG. 12 conceptually illustrates a process 1200 for receiving and using hierarchical grouping information from a streaming server. In some embodiments, one or more processing units (e.g., a processor) of a computing device implementing the streaming client 160 performs the process 1200 by executing instructions stored in a computer readable medium. In some embodiments, an electronic apparatus implementing the streaming client 160 performs the process 1200.

The client receives (at block 1210) a media content from a streaming server. The media content comprises a plurality of media tracks. The media content maybe segmented for the transmission to the streaming client.

The client receives (at block 1220) a first data structure (e.g., entity reference box) that specifies one or more arrays (e.g., entity reference type box) of entity identifiers for a first group of entities. The first group of entities may be a preselection specified by a Media Presentation Description (MPD). Each entity in the first group of entities may be a media track, an item, a track group, or a child group of entities (of the first group). Each array of entity identifiers includes one or more identifiers of the entities in the first group.

Each array of entity identifiers is also associated with one reference type that describes the entities identified by the array of entity identifiers. Different arrays of entity identifiers of the first group correspond to different reference types. A reference type for an array of entity identifiers of the first group may indicate that track and/or track group switching is allowed (“switchable”) during playback of the media content, or that track and/or track group preselection is allowed (“selectable”) only before playback and not during playback of the media content, or that members of a child entity group are to be played back together (“joint”).

In some embodiments, the first group of entities is one of a plurality of groups of entities of the media content. The streaming server provides a second data structure (e.g., groups list box) that specifies a group type for each group in the plurality of groups of entities. The second data structure comprises a plurality of boxes (e.g., entity-to-group boxes) that correspond to the plurality of groups of entities. A box that corresponds to the first group of entities may refer to the first data structure (e.g., entity reference box). The group type specified for the first group of entities may indicate that members of the first group of entities are to be played back together (“joint”), or that the members of the first group of entities have no specified relationship during playback (“unspecified”).

The client provides (at block 1230) entities of the first group from the media content for playback according to the first data structure.

### II. Computing Environment

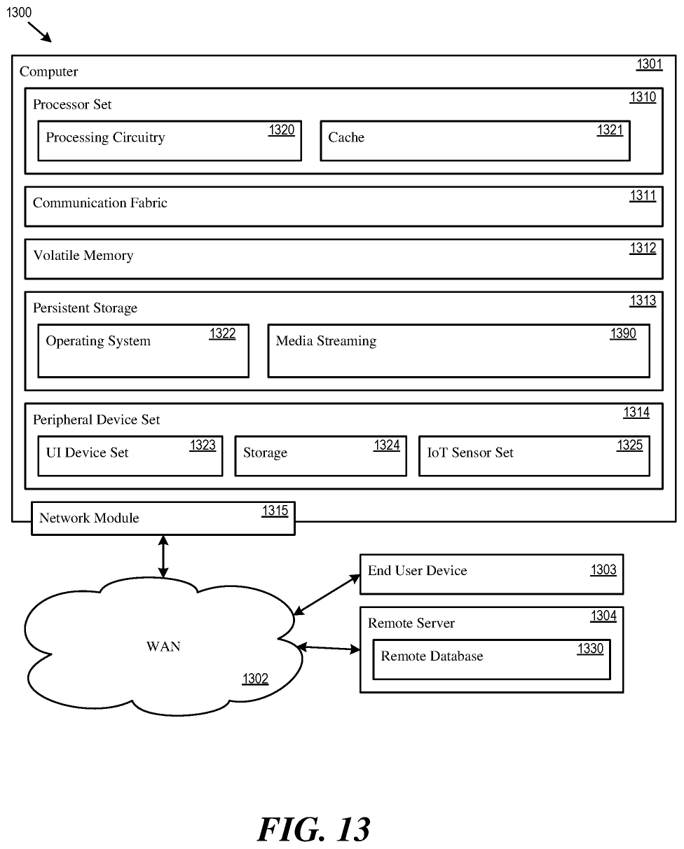

FIG. 13 conceptually illustrates an example computing environment 1300, consistent with some embodiments of the disclosure. The computing environment 1300 contains an example of an environment for the execution of at least some of the computer code involved in performing the inventive methods, such as a media streaming block 1390 performing the function of a streaming server or streaming client as described by reference to FIG. 11 and FIG. 12.

In addition to block 1390, computing environment 1300 includes, for example, computer 1301, wide area network (WAN) 1302, end user device (EUD) 1303, remote server 1304, public cloud 1305, and private cloud 1306. In this embodiment, computer 1301 includes processor set 1310 (including processing circuitry 1320 and cache 1321), communication fabric 1311, volatile memory 1312, persistent storage 1313 (including operating system 1322 and block 1390, as identified above), peripheral device set 1314 (including user interface (UI) device set 1323, storage 1324, and Internet of Things (IoT) sensor set 1325), and network module 1315. Remote server 1304 includes remote database 1330. Public cloud 1305 includes gateway 1340, cloud orchestration module 1341, host physical machine set 1342, virtual machine set 1343, and container set 1344.

COMPUTER 1301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1330. As is well understood in the art of computer technology, and depending upon the technology, performance of a computer-implemented method may be distributed among multiple computers and/or between multiple locations. On the other hand, in this presentation of computing environment 1300, detailed discussion is focused on a single computer, specifically computer 1301, to keep the presentation as simple as possible. Computer 1301 may be located in a cloud, even though it is not shown in a cloud in FIG. 13. On the other hand, computer 1301 is not required to be in a cloud except to any extent as may be affirmatively indicated.

PROCESSOR SET 1310 includes one, or more, computer processors of any type now known or to be developed in the future. Processing circuitry 1320 may be distributed over multiple packages, for example, multiple, coordinated integrated circuit chips. Processing circuitry 1320 may implement multiple processor threads and/or multiple processor cores. Cache 1321 is memory that is located in the processor chip package(s) and is typically used for data or code that should be available for rapid access by the threads or cores running on processor set 1310. Cache memories are typically organized into multiple levels depending upon relative proximity to the processing circuitry. Alternatively, some, or all, of the cache for the processor set may be located “off chip.” In some computing environments, processor set 1310 may be designed for working with qubits and performing quantum computing.

Computer readable program instructions are typically loaded onto computer 1301 to cause a series of operational steps to be performed by processor set 1310 of computer 1301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1321 and the other storage media discussed below. The program instructions, and associated data, are accessed by processor set 1310 to control and direct performance of the inventive methods. In computing environment 1300, at least some of the instructions for performing the inventive methods may be stored in block 1390 in persistent storage 1313.

COMMUNICATION FABRIC 1311 is the signal conduction path that allows the various components of computer 1301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1312 is any type of volatile memory now known or to be developed in the future. Examples include dynamic type random access memory (RAM) or static type RAM. Typically, volatile memory 1312 is characterized by random access, but this is not required unless affirmatively indicated. In computer 1301, the volatile memory 1312 is located in a single package and is internal to computer 1301, but, alternatively or additionally, the volatile memory may be distributed over multiple packages and/or located externally with respect to computer 1301.

PERSISTENT STORAGE 1313 is any form of non-volatile storage for computers that is now known or to be developed in the future. The non-volatility of this storage means that the stored data is maintained regardless of whether power is being supplied to computer 1301 and/or directly to persistent storage 1313. Persistent storage 1313 may be a read only memory (ROM), but typically at least a portion of the persistent storage allows writing of data, deletion of data and re-writing of data. Some familiar forms of persistent storage include magnetic disks and solid state storage devices. Operating system 1322 may take several forms, such as various known proprietary operating systems or open source Portable Operating System Interface-type operating systems that employ a kernel. The code included in block 1390 typically includes at least some of the computer code involved in performing the inventive methods.

PERIPHERAL DEVICE SET 1314 includes the set of peripheral devices of computer 1301. Data communication connections between the peripheral devices and the other components of computer 1301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1323 may include components such as a display screen, speaker, microphone, wearable devices (such as goggles and smart watches), keyboard, mouse, printer, touchpad, game controllers, and haptic devices. Storage 1324 is external storage, such as an external hard drive, or insertable storage, such as an SD card. Storage 1324 may be persistent and/or volatile. In some embodiments, storage 1324 may take the form of a quantum computing storage device for storing data in the form of qubits. In embodiments where computer 1301 is required to have a large amount of storage (for example, where computer 1301 locally stores and manages a large database) then this storage may be provided by peripheral storage devices designed for storing very large amounts of data, such as a storage area network (SAN) that is shared by multiple, geographically distributed computers. IoT sensor set 1325 is made up of sensors that can be used in Internet of Things applications. For example, one sensor may be a thermometer and another sensor may be a motion detector.

NETWORK MODULE 1315 is the collection of computer software, hardware, and firmware that allows computer 1301 to communicate with other computers through WAN 1302. Network module 1315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1315 are performed on the same physical hardware device. In other embodiments (for example, embodiments that utilize software-defined networking (SDN)), the control functions and the forwarding functions of network module 1315 are performed on physically separate devices, such that the control functions manage several different network hardware devices. Computer readable program instructions for performing the inventive methods can typically be downloaded to computer 1301 from an external computer or external storage device through a network adapter card or network interface included in network module 1315.

WAN 1302 is any wide area network (for example, the internet) capable of communicating computer data over non-local distances by any technology for communicating computer data, now known or to be developed in the future. In some embodiments, the WAN 1302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1303 is any computer system that is used and controlled by an end user (for example, a customer of an enterprise that operates computer 1301), and may take any of the forms discussed above in connection with computer 1301. EUD 1303 typically receives helpful and useful data from the operations of computer 1301. For example, in a hypothetical case where computer 1301 is designed to provide a recommendation to an end user, this recommendation would typically be communicated from network module 1315 of computer 1301 through WAN 1302 to EUD 1303. In this way, EUD 1303 can display, or otherwise present, the recommendation to an end user. In some embodiments, EUD 1303 may be a client device, such as thin client, heavy client, mainframe computer, desktop computer and so on.

REMOTE SERVER 1304 is any computer system that serves at least some data and/or functionality to computer 1301. Remote server 1304 may be controlled and used by the same entity that operates computer 1301. Remote server 1304 represents the machine(s) that collect and store helpful and useful data for use by other computers, such as computer 1301. For example, in a hypothetical case where computer 1301 is designed and programmed to provide a recommendation based on historical data, then this historical data may be provided to computer 1301 from remote database 1330 of remote server 1304.

### III. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

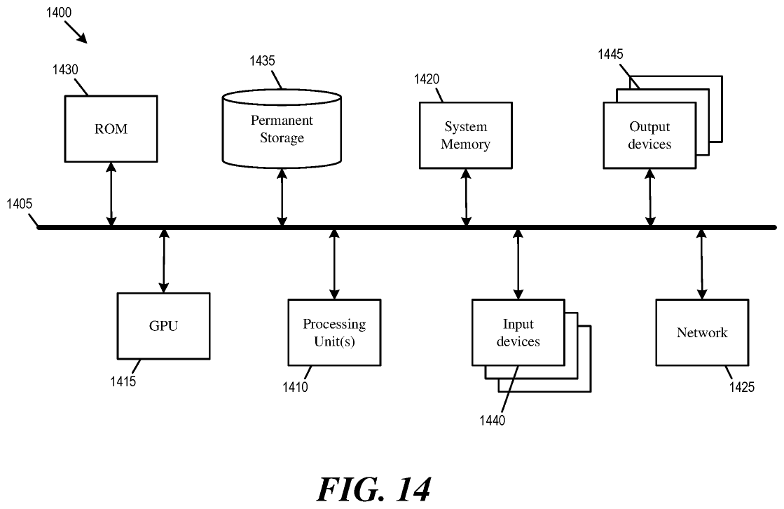

FIG. 14 conceptually illustrates an electronic system 1400 with which some embodiments of the present disclosure are implemented. The electronic system 1400 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1400 includes a bus 1405, processing unit(s) 1410, a graphics-processing unit (GPU) 1415, a system memory 1420, a network 1425, a read-only memory 1430, a permanent storage device 1435, input devices 1440, and output devices 1445.

The bus 1405 collectively represents all system, peripheral, and chipset buses that communicatively connect the numerous internal devices of the electronic system 1400. For instance, the bus 1405 communicatively connects the processing unit(s) 1410 with the GPU 1415, the read-only memory 1430, the system memory 1420, and the permanent storage device 1435.

From these various memory units, the processing unit(s) 1410 retrieves instructions to execute and data to process in order to execute the processes of the present disclosure. The processing unit(s) may be a single processor or a multi-core processor in different embodiments. Some instructions are passed to and executed by the GPU 1415. The GPU 1415 can offload various computations or complement the image processing provided by the processing unit(s) 1410.

The read-only-memory (ROM) 1430 stores static data and instructions that are used by the processing unit(s) 1410 and other modules of the electronic system. The permanent storage device 1435, on the other hand, is a read-and-write memory device. This device is a non-volatile memory unit that stores instructions and data even when the electronic system 1400 is off. Some embodiments of the present disclosure use a mass-storage device (such as a magnetic or optical disk and its corresponding disk drive) as the permanent storage device 1435.

Other embodiments use a removable storage device (such as a floppy disk, flash memory device, etc., and its corresponding disk drive) as the permanent storage device. Like the permanent storage device 1435, the system memory 1420 is a read-and-write memory device. However, unlike storage device 1435, the system memory 1420 is a volatile read-and-write memory, such a random access memory. The system memory 1420 stores some of the instructions and data that the processor uses at runtime. In some embodiments, processes in accordance with the present disclosure are stored in the system memory 1420, the permanent storage device 1435, and/or the read-only memory 1430. For example, the various memory units include instructions for processing multimedia clips in accordance with some embodiments. From these various memory units, the processing unit(s) 1410 retrieves instructions to execute and data to process in order to execute the processes of some embodiments.

The bus 1405 also connects to the input and output devices 1440 and 1445. The input devices 1440 enable the user to communicate information and select commands to the electronic system. The input devices 1440 include alphanumeric keyboards and pointing devices (also called “cursor control devices”), cameras (e.g., webcams), microphones or similar devices for receiving voice commands, etc. The output devices 1445 display images generated by the electronic system or otherwise output data. The output devices 1445 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 14, bus 1405 also couples electronic system 1400 to a network 1425 through a network adapter (not shown). In this manner, the computer can be a part of a network of computers (such as a local area network (“LAN”), a wide area network (“WAN”), or an Intranet, or a network of networks, such as the Internet. Any or all components of electronic system 1400 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 11 and FIG. 12) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A media delivery method comprising:
providing, at a streaming server, a media content to a streaming client, wherein the media content comprises a plurality of media tracks;
specifying, at the streaming server, a first group of entities for the media content, wherein each entity in the first group of entities is a media track, an item, a track group, or a child group of entities;
populating, at the streaming server, a first data structure that specifies one or more arrays of entity identifiers for the first group of entities, each array of entity identifiers comprising one or more identifiers of the entities in the first group,
wherein each array of entity identifiers is associated with one reference type that describes the entities identified by the array of entity identifiers; and
providing the first data structures to the streaming client.

2. The media delivery method of claim 1, wherein different arrays of entity identifiers of the first group correspond to different reference types.

3. The media delivery method of claim 1, wherein a first array of entity identifiers comprises identifiers for tracks, items, or groups of entities.

4. The media delivery method of claim 1, wherein the first group of entities is a preselection specified by a Media Presentation Description (MPD).

5. The media delivery method of claim 1, wherein a first reference type for a first array of entity identifiers of the first group indicates that track and track group switching is allowed during playback of the media content.

6. The media delivery method of claim 1, wherein a first reference type for a first array of entity identifiers of the first group indicates that track and track group preselection is allowed only before playback and not during playback of the media content.

7. The media delivery method of claim 1, wherein a first reference type of a first array of entity identifiers of the first group indicates that tracks, track groups and members of a child entity group are to be played back together.

8. The media delivery method of claim 1, wherein the first group of entities is one of a plurality of groups of entities of the media content, wherein the streaming server provides a second data structure that specifies a group type for each group in the plurality of groups of entities.

9. The media delivery method of claim 8, wherein the second data structure comprises a plurality of boxes that correspond to the plurality of groups of entities, wherein a box that corresponds to the first group of entities refers to the first data structure.

10. The media delivery method of claim 8, wherein the group type specified for the first group of entities indicate that members of the first group of entities are to be played back together.

11. The media delivery method of claim 8, wherein the group type specified for the first group of entities indicate that members of the first group of entities have no specified relationship but alternatively during playback.

12. The media delivery method of claim 1, wherein the media content is segmented for the transmission to the streaming client.

13. A media playback method comprising:
receiving, at a streaming client, a media content from a streaming server, wherein the media content comprises a plurality of media tracks;
receiving, at the streaming client, a first data structure that specifies one or more arrays of entity identifiers for a first group of entities, each entity in the first group of entities being a media track, an item, a track group, or a child group of entities,
wherein each array of entity identifiers (i) comprises one or more identifiers of the entities in the first group and (ii) is associated with one reference type that describes the entities identified by the array of entity identifiers; and
providing entities of the first group from the media content for playback according to the first data structure.

14. An electronic apparatus comprising:
a circuit configured to perform operations comprising:
providing a media content to a streaming client, wherein the media content comprises a plurality of media tracks;
specifying a first group of entities for the media content, wherein each entity in the first group of entities is a media track, an item, a track group, or a child group of entities;
populating a first data structure that specifies one or more arrays of entity identifiers for the first group of entities, each array of entity identifiers comprising one or more identifiers of the entities in the first group, wherein each array of entity identifiers is associated with one reference type that describes the entities identified by the array of entity identifiers; and
providing the first data structure to the streaming client.

15. A computer program product comprising:
one or more non-transitory computer-readable storage devices and program instructions stored on at least one of the one or more non-transitory storage devices, the program instructions executable by a processor, the program instructions comprising sets of instructions for:
receiving, at a streaming client, a media content from a streaming server, wherein the media content comprises a plurality of media tracks;
receiving, at the streaming client, a first data structure that specifies one or more arrays of entity identifiers for a first group of entities, each entity in the first group of entities being a media track, an item, a track group, or a child group of entities,
wherein each array of entity identifiers (i) comprises one or more identifiers of the entities in the first group and (ii) is associated with one reference type that describes the entities identified by the array of entity identifiers; and
providing entities of the first group from the media content for playback according to the first data structure.
